(19) United States
(12) Patent Application Publication
(10) Pub. No.: US 2003/0074927 A1
(43) Pub. Date: Apr. 24, 2003

(54) Dual-type system for producing optical fibers

(76) Inventors: Youn-Ho Kuk, Susung Gu (KR); Tae-Youn Ko, Seo-Gu (KR)

Correspondence Address: Paul J. Farrell, Esq., DIL WORTH & BARRESE, LLP, 333 Earle Ovington Blvd., Uniondale, NY, 11553, US

(21) Appl. No.: 10/072,049

(22) Filed: Feb. 6, 2002

(30) Foreign Application Priority Data
Oct. 22, 2001 (KR) 2001-0032158

(51) Int. Cl. C03B 37/10; C03B 37/07

(52) U.S. Cl. 65/491; 65/510; 65/530

(57) ABSTRACT

Disclosed herein is a dual-type system for producing optical fibers. According to this system, a draw tower is partitioned into a first spinning chamber and a second spinning chamber by a central partition frame. A preform feed unit, a furnace, a spinning nozzle and a diameter gauge are installed on each of the first and second spinning chambers in order to spin an optical fiber. Two coating units are installed at the lowest unit of the draw tower at positions corresponding to the first and second spinning chambers and used for coating the surfaces of the optical fibers spun and drawn through the first and second spinning chambers. Two ducts each having a filter are installed on a side of each unit of the draw tower at positions corresponding to the first and second spinning chambers for supplying fresh air to the optical fibers so as to prevent the optical fibers from absorbing foreign substances in addition to cooling the optical fibers.

### PRIORITY

This application claims priority to an application entitled “Dual-Type System for Producing Optical Fibers” filed in the Korean Industrial Patent Office on Oct. 22, 2001 and assigned Serial No. 2001-32158, the contents of which are hereby incorporated by reference.

### BACKGROUND OF THE INVENTION

1. Field of the Invention

The present invention relates generally to a dual-type system for producing optical fibers, and more particularly, to a system for producing optical fibers or synthetic fibers, which is structurally improved to utilize a space effectively, in addition to having high productivity while producing such fibers.

2. Description of the Prior Art

As is well known to those skilled in the art, an optical fiber is a wave guide having the same shape as that of a fiber and functions to transmit light. Such an optical fiber is generally made of synthetic resins and glasses. Above all, glass having superior transparency is mainly used as a material of the optical fiber.

Such an optical fiber 30, as shown in FIG. 2, has a shape of a concentric circle when taken in a cross sectional view; that is, it consists of a core section 31 positioned along the central axis of the optical fiber 30, a cladding section 32 surrounding the core 31, and an outer coating section 33 made of appropriate materials, such as synthetic resins for protecting the optical fiber 30 from external conditions, such as impact.

A typical diameter of the optical fiber is one hundred˜several hundred micrometers. Since the refractivity of the core section 31 is higher than that of the cladding section 32, the light is concentrated into the core section 31 without being dispersed to the outside, and the light progresses along the length of the fiber.

Such an optical fiber is advantageous in that there is no interference by electromagnetic waves, or the danger of wiretapping. Furthermore, the optical fiber has another advantage in that it is small in size in addition to being light weight, and has superior flexibility. The optical fiber has still another advantage in that there are many communication circuits received per one optical fiber. Therefore, recently, optical fibers have been widely used for communication, in addition to image transmission and detection.

There are several methods to produce such optical fibers, including a method using a melting pot, an external deposition method, an internal deposition method, an axial deposition method, a spinning method, etc. Of these, the spinning method has been the most widely used to produce the optical fibers. According to this spinning method, a preform consisting of rods having the same structure as that of the optical fiber with about 1 cm in diameter is melted by intense heat and then drawn to a predetermined length, thus obtaining a desired optical fiber.

A conventional system 40 for producing optical fibers 30 by the spinning method is shown in FIG. 1, and will be described hereinafter.

This system 40 includes a draw tower 43, a preform feed unit 44, a furnace 45 and a spinning nozzle 46. The draw tower 43 is set on a support surface and fabricated by vertically assembling a plurality of units 42 to have a predetermined height from the support surface. The preform feed unit 44 is installed on the draw tower 43 for feeding a preform to the draw tower 43. The furnace 45 melts the preform fed from the preform feed unit 44. The spinning nozzle 46 discharges the molten preform fed from the furnace 45 to form an optical fiber 30 having a fine diameter. A diameter gauge 47 is installed below the spinning nozzle 46 and measures the diameter of the optical fiber 30 discharged from the nozzle 46. The optical fiber 30 passes through the draw tower 43 positioned under the diameter gauge 47 while being cooled. A coating unit 49 is installed at the lower portion of the draw tower 43 for allowing the optical fiber 30 to be easily wound around a winding roller 50 in addition to preventing degradation and abrasion of the optical fiber 30.

The process of producing the optical fiber 30 by means of the system 40 is as follows. First, the preform fed to the furnace 45 is melted, and then discharged from the spinning nozzle 46 while being drawn to obtain an optical fiber having a fine diameter. While the drawn optical fiber passes through the draw tower 43, it is cooled. Thereafter, the optical fiber passes through the coating unit 49, which coats the surface of the optical fiber with a coating material. Finally, the optical fiber is wound around the winding roller 50.

As shown in FIG. 6, a top plan view of conventional system for producing optical fibers, a conventional dual type system is provided. Each draw tower 43 has a spinning chamber as well as a cooling chamber. That is, a plurality of main support frames 2 and 3 are vertically set up to form a square structure. A plurality of sub-support frames 4 and 5 are alternately connected to the main support frames 2 and 3 in a horizontal direction or in a diagonal direction, thus completing a main frame 6. The main frame 6 is partitioned into a spinning chamber 9 and a cooling chamber 13 by a central partition frame 7. The optical fiber is spun in the spinning chamber 9. A blower 12, having a filter 10 as well as a duct 11, is installed on the cooling chamber 13. A central frame is provided between the two tower frames in order to support them. In this case, three frames are needed.

The conventional dual type system for producing optical fibers has a problem in that its space utilization is undesirably poor, thus having low production efficiency, since the spinning chamber and the cooling chamber of this system occupy an excessively large space.

### SUMMARY OF THE INVENTION

Accordingly, the present invention has been made keeping in mind the above problems occurring in the prior art, and an object of the present invention is to provide a dual-type system for producing optical fibers, which provides a tower frame having two spinning chambers without changing the size of the draw tower, thus increasing space utilization, to allow many optical fibers to be produced in a small space, thereby improving productivity.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic view showing a conventional system for producing optical fibers;

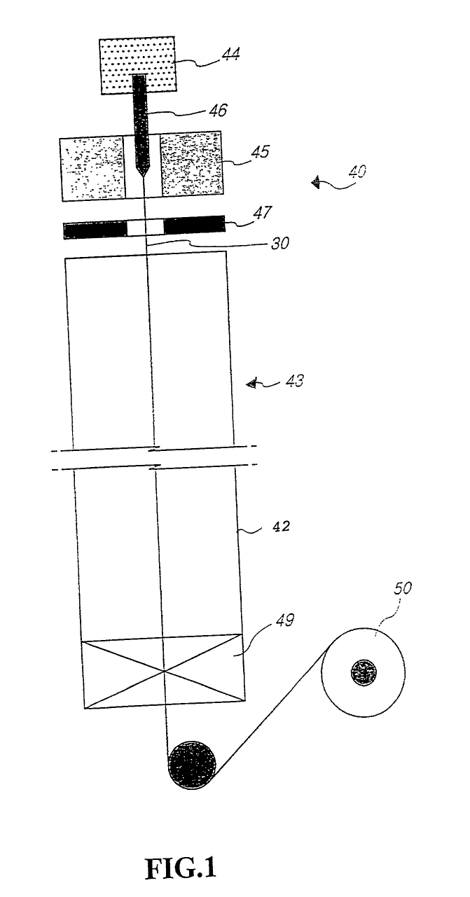

FIG. 2 is a cross-sectional view of an optical fiber;

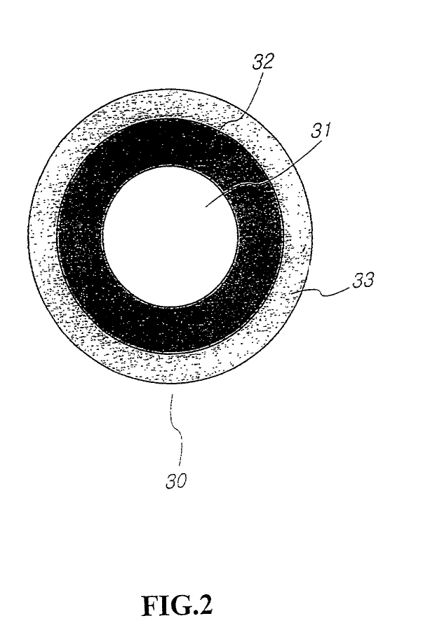

FIG. 3 is a front view of a draw tower of a dual-type system for producing optical fibers according to the present invention;

FIG. 4 is a cross-sectional view of the draw tower of the dual-type system for producing optical fibers of this invention, taken along the line A-A of FIG. 3;

FIG. 5 is a schematic view of the dual-type system for producing optical fibers of this invention; and

FIG. 6 is a top plan view of conventional dual type system.

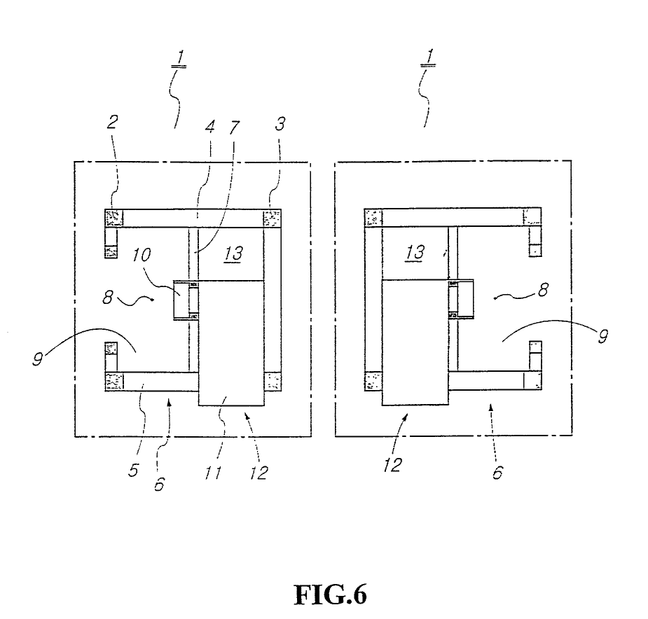

### DETAILED DESCRIPTION OF THE INVENTION

Reference now should be made to the drawings, in which the same reference numerals are used throughout the different drawings to designate the same or similar components.

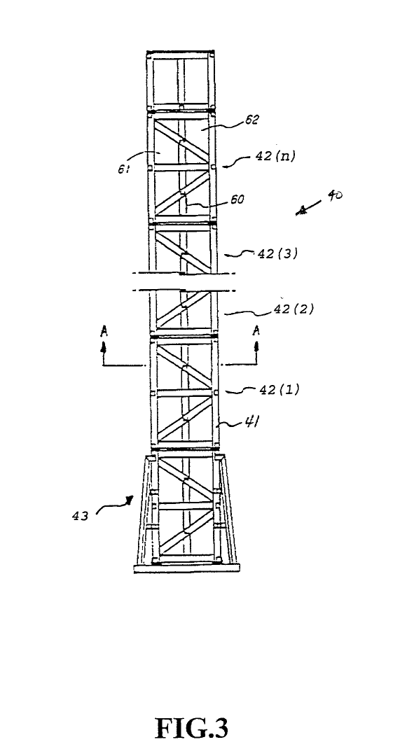

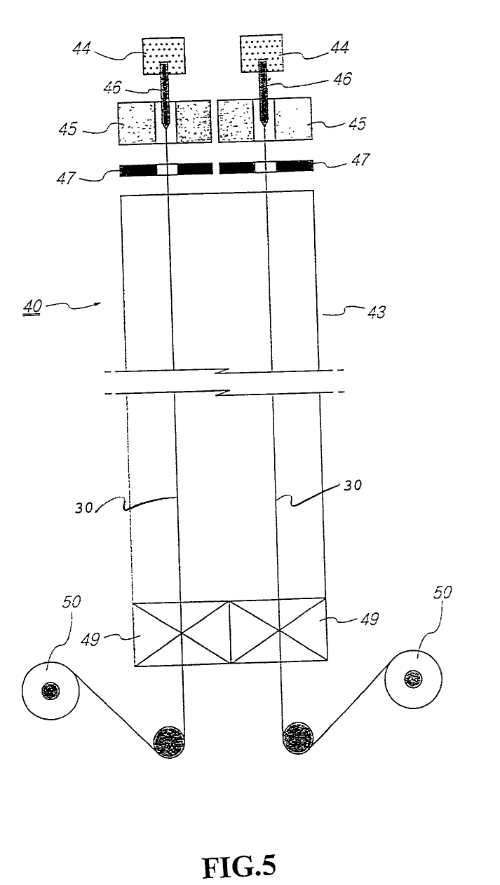

Referring to the drawings and in particular to FIGS. 3, 4 and 5, a dual-type system 40 for producing optical fibers includes a draw tower 43, a pair of preform feed units 44, a pair of furnace 45 and a pair of spinning nozzles 46. Although two preform feed units 44 and two furnaces 45 are shown schematically in FIG. 5, these elements may be provided as a single preform feed unit having dual outlets, and a single furnace. The draw tower 43 is set on a support surface and fabricated by vertically assembling a plurality of units 42(1)- 42(n) each made up of a framework 41 to have a predetermined height from the support surface. The preform feed unit 44 is installed on the draw tower 43 for feeding a preform to the draw tower 43. The furnace 45 melts the preform fed from the preform feed unit 44. The spinning nozzles 46 discharge the molten preform fed from the furnace 45 to form optical fibers 30 having a fine diameter.

A diameter gauge 47 is installed below each of the spinning nozzles 46 and measures the diameter of the optical fiber 30 discharged from each nozzle 46. A coating unit 49 is installed at a lower portion of the draw tower 43 for allowing optical fibers 30 to be easily wound around a winding roller 50 in addition to preventing degradation and abrasion of the optical fiber 30.

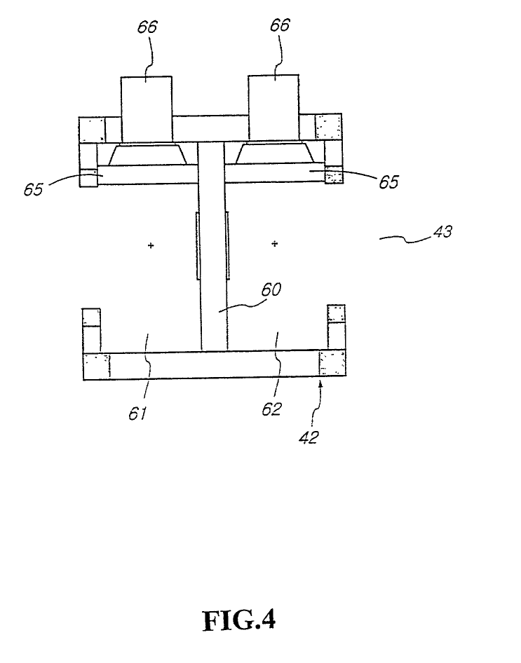

As best seen in FIG. 4, the draw tower 43 is partitioned into a first spinning chamber 61 and a second spinning chamber 62 by a central partition frame member 60. In a first embodiment, a preform feed unit 44, a furnace 45, a spinning nozzle 46 and a diameter gauge 47 are installed on each of the first and second spinning chambers 61 and 62 in order to spin an optical fiber 30 in each chamber 61 or 62. Alternatively, a single preform feed unit and furnace may be provided.

As seen in FIG. 5, two coating units 49 are installed at the lowest unit 42 (1) of the draw tower 43 at positions corresponding to the first and second spinning chambers 61 and 62, and used for coating the surfaces of the optical fibers 30 spun and drawn through the first and second spinning chambers 61 and 62. Alternatively, a single coating unit may be provided, which may accommodate multiple fibers.

Referring back to FIG. 4, two ducts 66 each having a filter 65 are installed on a side of each unit 42 of the draw tower 43 at positions corresponding to the first and second spinning chambers 61 and 62 for supplying fresh air to the optical fibers 30. The fresh air prevents the optical fibers 30 from absorbing foreign substances, in addition to cooling the optical fibers 30. Alternatively, a single unit may be provided, having multiple outlets, to accommodate the multiple spinning chambers.

The process of producing optical fibers using the above system 40 is as follows. First, the preform is supplied from a preform source, i.e. preform feed unit 44, to the system 40 of this invention, and then melted by the furnace 45. The molten preform is discharged through two spinning nozzles 46 and drawn in order to form two optical fibers 30 having a fine diameter.

The diameter of the drawn optical fibers 30 is continuously measured at diameter gauge 47 to maintain a uniform diameter along their length. While the optical fibers 30 pass through the spinning chamber 61 and 62 of the draw tower 43, air is supplied from the ducts 66 of each unit 42 to the optical fibers 30 after being filtered by the filter 65. This filtered air supplied to the optical fiber 30 prevents the optical fibers 30 from absorbing foreign substances, in addition to cooling the optical fibers 30.

Thereafter, a coating material is coated on the optical fibers 30 by the coating units 49 installed at the lowest unit 42 (1) of the draw tower 43, thus forming a coating layer 33 on each optical fiber 30. Finally, the optical fibers 30 are wound around the winding rollers 50.

The dual-type optical fiber producing system 40 according to this invention is designed to have a dual-type structure, that is, accommodate double units within the same space as that of the conventional system, thus being capable of producing the optical fibers at double the speed.

As described above, the present invention provides a dual-type system for producing optical fibers, which is structurally improved to have two spinning chambers without changing the size of the draw tower, thereby increasing space utilization, and allowing multiple optical fibers to be produced in a small space, to improve productivity.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. In dual-type system for producing optical fibers, including a vertical draw tower having a plurality of units each made up of a framework, a preform feed unit installed on a top portion of said draw tower for feeding a preform to the draw tower, a furnace for melting the preform fed from said preform feed unit, a spinning nozzle discharging the molten preform fed from said furnace to form an optical fiber, a diameter gauge installed below said spinning nozzle for measuring a diameter of an optical fiber discharged from said nozzle, a coating unit installed at a lower portion of said draw tower for coating a surface of the optical fiber with a coating material, the improvement which comprises:
a first spinning chamber and a second spinning chamber defined in said draw tower and each having a preform feed unit, a furnace, a spinning nozzle, and a diameter gauge installed thereon in order to spin an optical fiber;
two coating units installed at a lowest-most unit of the draw tower at positions corresponding to the first and second spinning chambers for coating the surfaces of optical fibers spun and drawn through said first and second spinning chambers; and
at least one duct having a filter installed on a side of each unit of said draw tower at positions corresponding to the first and second spinning chambers for supplying fresh air to the optical fibers.

2. The dual-type system for producing optical fibers according to claim 1, wherein the vertical draw tower is set on a support surface.

3. The dual-type system for producing optical fibers according to claim 1, wherein the first spinning chamber and the second spinning chamber are partitioned by a central partition frame.

4. A dual-type system for producing optical fibers, comprising:
a vertical draw tower having a plurality of units each made up of a framework, the draw tower partitioned into a first spinning chamber and a second spinning chamber;
a pair of preform feed units, each preform feed unit installed on a top portion of said draw tower for feeding a preform to the draw tower;
a pair of furnaces for melting the preform fed from said preform feed units;
a pair of spinning nozzles discharging the molten preform fed from said furnaces to form optical fibers;
a pair of diameter gauges, each installed below said spinning nozzles for measuring a diameter of an optical fiber discharged from each of said nozzles;
a pair of coating units installed at a lowest-most unit of the draw tower at positions corresponding to the first and second spinning chambers for coating the surfaces of optical fibers spun and drawn through said first and second spinning chambers; and
a pair of ducts having a filter installed on said draw tower at positions corresponding to the first and second spinning chambers for supplying fresh air to the optical fibers.

5. A dual-type system for producing optical fibers, comprising:
a vertical draw tower having a plurality of units each made up of a framework, the draw tower partitioned into a first spinning chamber and a second spinning chamber;
at least one preform feed unit, the preform feed unit installed on a top portion of said draw tower for feeding at least one preform to the draw tower;
at least one furnace for melting the at least one preform fed from said at least one feed unit;
a pair of spinning nozzles discharging the molten at least one preform to form optical fibers;
a pair of diameter gauges, each installed below said spinning nozzles for measuring a diameter of an optical fiber discharged from each of said nozzles;
at least one coating unit installed at a lowest-most unit of the draw tower for coating the surfaces of optical fibers spun and drawn through said first and second spinning chambers; and
at least one duct having a filter installed on said draw tower for supplying fresh air to the optical fibers.

6. In dual-type system for producing optical fibers, including a vertical draw tower having a plurality of units each made up of a framework, a pair of preform feed units installed on a top portion of said draw tower each for feeding a preform to the draw tower, at least one furnace for melting the preforms fed from said preform feed units, a pair of spinning nozzles discharging the molten preforms fed from said furnace to form optical fibers, a pair of diameter gauges installed below each of said spinning nozzle for measuring a diameter of an optical fiber discharged from each of said nozzles, and a coating unit installed at a lower portion of said draw tower for coating a surface of each optical fiber with a coating material, comprising a draw tower having a first spinning chamber and a second spinning chamber defined in said draw tower.
